(19) United States
(12) Patent Application Publication
(10) Pub. No.: US 2014/0156481 A1
(43) Pub. Date: Jun. 5, 2014

(54) USING A FINANCIAL ACCOUNT STATEMENT TO PRESENT AN OPPORTUNITY TO PROVIDE CONTENT RELATED TO A GOOD OR SERVICE

(71) Applicant: BAZAARVOICE, INC., Austin, TX (US)

(72) Inventor: Jamison Gilveli, Austin, TX (US)

(73) Assignee: BAZAARVOICE, INC., Austin, TX (US)

(21) Appl. No.: 13/691,607

(22) Filed: Nov. 30, 2012

(51) Int. Cl. G06Q 30/00

(52) U.S. Cl. CPC G06Q 30/00
USPC 705/35

(57) ABSTRACT

Techniques for determining that an opportunity to solicit content from a user are described. Such content may relate to a user's experience with goods or services purchased by the user with a financial account (e.g., a credit card). Account information and/or transaction information may be analyzed to determine that a content submission opportunity exists. After determining that a content submission opportunity exists, a link may be inserted into a financial account statement allowing the user to provide the content. Multiple content or content types may be submitted for a single purchase (e.g., for different items in a purchase). Other variations are also described.

### BACKGROUND

This disclosure relates to user-provided content (e.g., product feedback) that may be related to a good or service, including the ability to submit content in association with a statement for a financial account.

Certain websites (such as YELP.COM, etc.) may allow people to leave reviews (or provide other feedback or content) for restaurants, consumer goods, or other products or services. One disadvantage of such websites, however, is that a person may have to make a special effort in order to leave a review. For example, after dining at a particular restaurant, a diner may have to seek a computing device, log onto a review website such as YELP, search for the particular restaurant, and then write a review. Similarly, a consumer that has purchased a particular product may also have to make a special effort to leave feedback for that particular product.

In a single month, a typical person may make dozens or even hundreds of purchases for which the person could potentially leave feedback. However, attempting to manually submit feedback for these purchases (e.g., without any prompting) may be an exhausting process. In some cases, a purchaser may not end up leaving a review simply because determining how to leave a review takes too much time. In other cases, a purchaser may not leave a review because the purchaser has simply forgotten to do so (e.g., due to a large number of other purchases).

The inability for users to conveniently leave reviews (or provide other content) may result in a provider of a good and/or service receiving a lesser quantity of valuable feedback information. Failure to allow convenient submission of user generated content may also cause overall knowledge about a particular good or service to be reduced

### BRIEF DESCRIPTION OF THE DRAWINGS

FIG. 1 is a diagram depicting one embodiment of a system overview.

FIG. 2 is a diagram showing one embodiment of an account statement (e.g., a monthly credit card statement).

FIG. 3 is a flow chart of one embodiment of a method that relates to determining the existence of an opportunity to solicit content for a good or service.

FIG. 4 is a flow chart of one embodiment of a method that relates to transmitting information usable to cause an opportunity to submit UGC to be presented on a computer system display.

FIG. 5 is a diagram depicting one embodiment of a computer readable medium having at least two modules.

FIG. 6 is a diagram of one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The following paragraphs provide definitions and/or context for terms found in this disclosure (including the appended claims):

“Comprising.” This term is open-ended. As used herein, this term does not foreclose additional structure or steps. Consider a claim that recites: “a system comprising a processor and a memory . . . .” Such a claim does not foreclose the system from including additional components such as interface circuitry, a graphics processing unit (GPU), etc.

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation(s), etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

“First,” “Second,” etc. As used herein, these terms are used as labels for nouns that they precede unless otherwise noted, and do not imply any type of ordering (e.g., spatial, temporal, logical, etc.). For example, a “first” computing system and a “second” computing system can be used to refer to any two computing systems. In other words, “first” and “second” are descriptors.

“Based On” or “Based Upon.” As used herein, these terms are used to describe one or more factors that affect a determination. These terms do not foreclose additional factors that may affect a determination. That is, a determination may be solely based on the factor(s) stated or may be based on one or more factors in addition to the factor(s) stated. Consider the phrase “determining A based on B.” While B may be a factor that affects the determination of A, such a phrase does not foreclose the determination of A from also being based on C. In other instances, however, A may be determined based solely on B.

“Financial account.” As used herein, this term includes its ordinary meaning and may refer, in various embodiments, to a credit account, debit account, and/or a rewards account. In some embodiments, a financial account may include two or more components or aspects (e.g., a financial account may include a credit account and an associated rewards account or program).

“Provider.” As used herein, this term includes its ordinary meaning and may refer, in various embodiments, to a manufacturer, offeror of services, restaurant, reseller, retailer, wholesaler, and/or distributor.

“Plurality.” As used herein, this term includes its ordinary meaning. In one embodiment, “plurality of goods or services” may refer to at least one good and at least one service, to at least two goods and zero services, or to at least two services and zero goods.

“Link.” As used herein, this term includes its ordinary meaning, and includes a Universal Resource Identifier (URI), such as a hyperlink to a resource or location on a network such as the Internet.

“User generated content” (UGC). As used herein, this term refers to text, audio, video, or another information carrying medium that is generated by a user who may be a consumer of something (e.g., of goods, a product, a website, a service), a purchaser of that something, or may otherwise have an interest in that something. User generated content includes, in various embodiments, user reviews, user stories, ratings, comments, problems, issues, questions, answers, opinions, or other types of content.

Structures and techniques described herein allow a user to submit user generated content relating to a good or service via an account statement such as a monthly credit card bill. Such content may be a review or question of a product, store, brand, etc., or other type of content as discussed herein. By providing a link to a content review website from within an account statement, for example, it may be more convenient for a user to generate and submit content.

A user of a financial account related to a credit card, debit card, etc., may receive an electronic monthly statement or bill that lists previous purchases (e.g., purchases made during a relevant billing period). A user receiving such a statement may review it, for example, to confirm that there are no fraudulent or unauthorized charges.

According to the techniques disclosed herein, as part of the account statement review process, a user may be given the opportunity to provide feedback that relates to a particular transaction. For example, an account statement may include a visual element selectable to navigate to a content submission page relating to a particular product or service.

In some embodiments, an analysis of account and/or transaction information may be used to determine whether an opportunity to submit user generated content exists and/or whether such an opportunity should be presented to a user. For example, not every single purchase or transaction detail on an account statement may have an associated content submission opportunity. Based on user preferences, business rules, prior agreements, or other information, however, a computer system may determine that a particular content submission opportunity exists and should be presented to a user as part of an account statement. In one embodiment, a provider (e.g., a retail store) may provide information to another computer system that allows a user to submit different content for different items made in a single purchase.

However, note that the teachings of this disclosure and the claims are expressly not limited by the features, embodiments, and/or benefits discussed above.

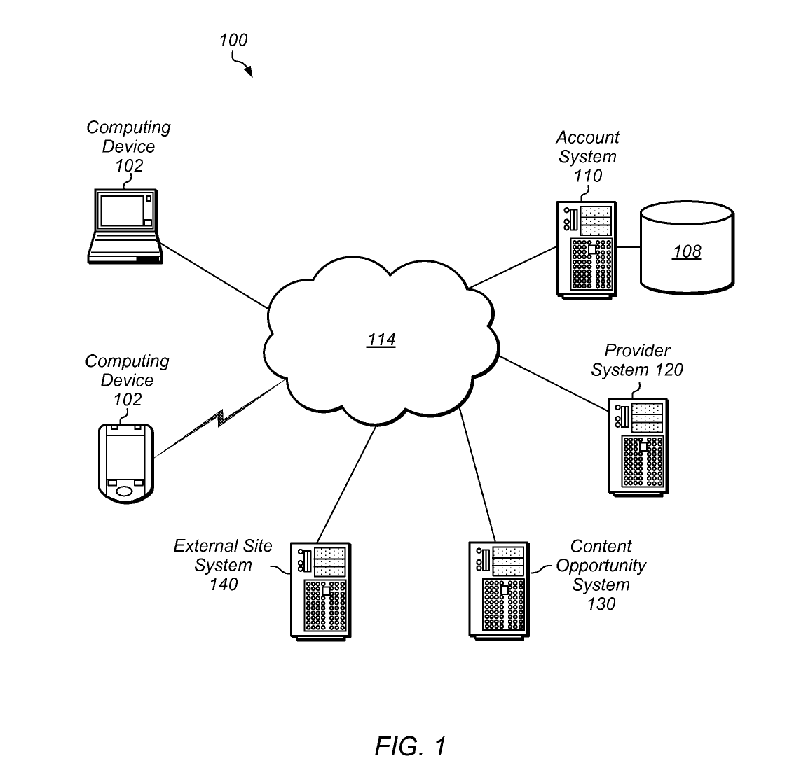

Turning now to FIG. 1, a diagram 100 depicting one embodiment of a system overview is shown. In this figure, one or more user computing devices 102 are in communication with one or more of systems 110-140 via a network 114. Network 114 may be the Internet in some embodiments, and may include one or more other networks (not depicted), wired or wireless communication links, etc.

User computing device 102 may be a mobile device, laptop, desktop, or other type of computing system. In various embodiments, user computing device 102 may correspond to one or more aspects of computer system 600 (described below relative to FIG. 6). Likewise, each of systems 110-140 may by any type of computing system, and in various embodiments may correspond to one or more aspects of computer system 600. In some embodiments, a user computing device 102 is associated with a particular user who is an owner or authorized user of a financial account managed by or associated with account system 110.

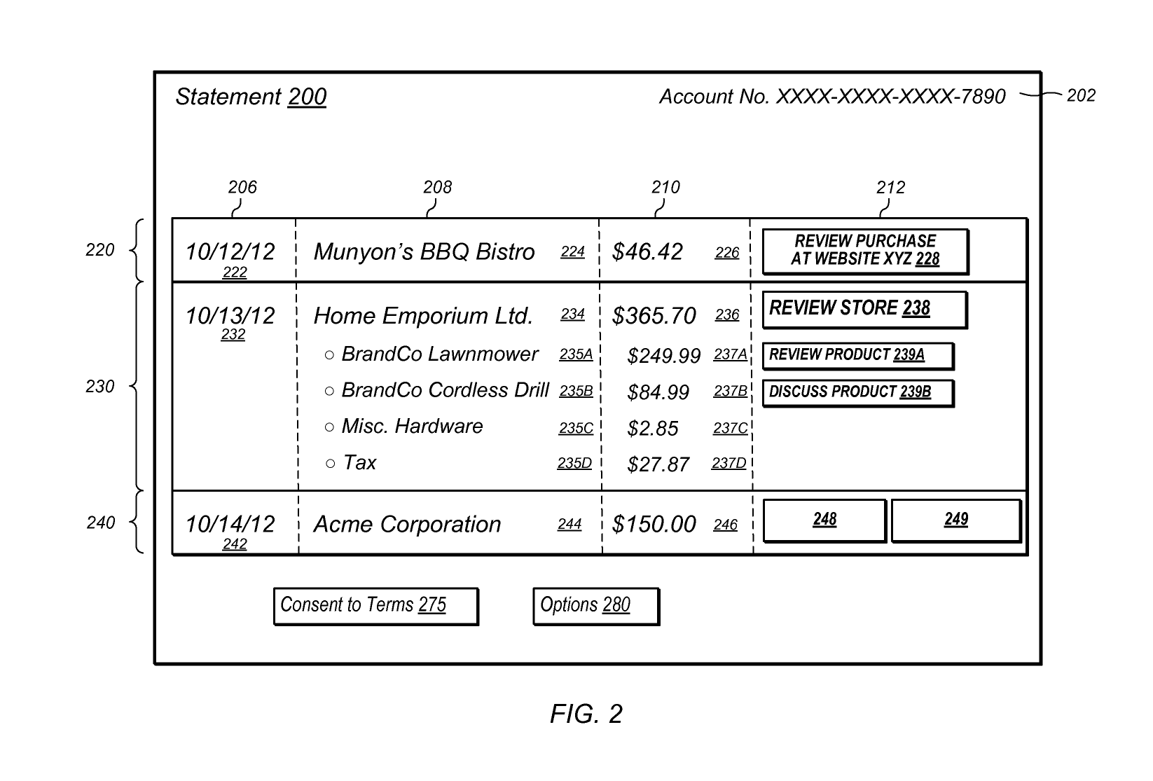

Account system 110 is owned by (or associated with) a credit card company, bank, credit union, financial services company, and/or other entity in various embodiments. For example, account system 110 may be owned by a bank affiliated with credit card companies MASTERCARD or VISA in some embodiments. In one embodiment, account system 110 is configured to create and/or transmit account statements. As discussed relative to FIG. 2, an account statement may include a statement or summary of charges for a given period of time (e.g., one month's worth of charges).

As shown, database 108 includes various account and/or transaction information related to one or more financial accounts that are associated with system 110. In various embodiments, database 108 may be at least partly implemented using hardware and/or software that is part of system 110, or may be at least partly implemented within one or more other computer systems (not depicted). In various embodiments, database 108 may include account numbers, billing information (including email addresses and/or other user contact information), and transaction information. The transaction information in database 108 may include a history of charges for each of a plurality of accounts. Each transaction having an entry in database 108 may be associated, in various embodiments, with one or more purchase-related details such as date and time of transaction, information specifying or describing one or more purchased goods or services, information identifying a provider from which one or more goods or services were purchased, total amount of transaction, and/or one or more amounts for one or more transaction portions (e.g., a single good or service or group of goods and/or services).

Provider system 120 may be any computer system that is associated with a provider of goods and/or services. Provider system 120 may include, in various embodiments, a register, a point-of-sale terminal, a system that is configured to host a website associated with the provider, or any other type of computer system. Provider system 120 may be used, in various embodiments, to facilitate a purchase made at a “brick and mortar” store or to facilitate a purchase made over a network such as the Internet.

Transaction information is received at database 108 from one or more of systems 110-140 in various embodiments. In one embodiment, one or more provider systems 120 transmit information to system 110 and/or database 108. When a purchase is made at a provider associated with provider system 120, for example, all pertinent transaction details may be sent to database 108 (possibly via system 110). In one embodiment, system 110 may receive some or all transaction information after a purchase is made. For example, as part of determining whether an opportunity exists to solicit user generated content relating a user's experience with a good or service associated with a charge, account system 110 may retrieve additional information from provider system 120 after the time of purchase. E.g., system 110 may receive first information from system 120, and then receive additional information from system 120 at a later time. The first information might be received at or near a time of purchase, while the additional information could be received minutes, hours, days, or weeks later in various embodiments. In one embodiment, account system 110 contacts system 120 to get additional details regarding a particular good or services that was purchased, such as the price, model number or other identifying detail, etc., for a particular item (whereas earlier-received transaction information might only have included a total purchase amount, for example, or a description of a good that did not include a model number).

Content opportunity system 130 may, in various embodiments, be configured to make a determination as to whether an opportunity exists for a user to provide user generated content relating to a good or service. In some embodiments, content opportunity system 130 is configured to receive account information from account system 110, transaction information from provider system 120, and/or receive information from external site system 140 (such as information related to reviews). In some embodiments, content opportunity system 130 is controlled by or associated with an entity other than entities that own systems 110, 120, and/or 140 (e.g., a third-party content processing entity).

As shown in FIG. 1, external site system 140 may be affiliated with an entity or website other than an entity or website that corresponds to one of systems 110-130. In one embodiment, external site system 140 is configured to host a “third party review site” that collects or hosts reviews or other user generated content. For example, in various embodiments, external site system 140 may correspond to YELP.COM, ANGIESLIST.COM, YAHOO.COM, GOOGLE.COM, or other such companies and/or websites.

Turning now to FIG. 2, one embodiment of an account statement 200 is shown. Account statement 200 may include an account number 202, which may be at least partially obscured in some embodiments. Account statement 200 may include fields 206, 208, 210, and 212, as well as other information not depicted. In the embodiment shown, fields 206, 209, 210, and 212 respectively correspond to transaction dates, provider descriptions, costs of transactions and/or goods or services, and content generation opportunities. Three different transaction entries 220, 230, and 240 are also indicated on FIG. 2.

Account statement 200 may be presented, accessed, or displayed as part of a website affiliated with an entity that controls, manages, or is affiliated with a user's financial account. For example, account statement 200 may be presented after a user logs in to a website affiliated with a credit card company, bank, credit union, etc. Account statement 200 may also be emailed to a user in some embodiments. In various embodiments, account statement 200 is included in at least a portion of a web page, and may include HTML, script, or other content and/or executable code. In another embodiment, account statement 200 is an ADOBE PORTABLE DOCUMENT FILE (PDF).

In the embodiment of FIG. 2, visual elements depicted in fields 212 (such as element 228) may correspond to an opportunity to submit content relating to a good or service (e.g., an opportunity to submit user generated content). In various embodiments, visual elements in fields 212 may include one or more of text, graphics, and/or animations. Thus in one embodiment, a visual element may include only text, without other graphics (e.g., a text hyperlink), while in other embodiments the visual element may be non-text graphics (e.g., an image hyperlink) or text mixed with other graphics (e.g., a button that includes text). Note that as used herein, the term “visual element” does not preclude an element from having other features (e.g., an aural component in which noise is emitted upon a mouseover event), but simply denotes that an element includes information that can be visually depicted on a display of a computer system. In the embodiment of FIG. 2, each of the visual elements in field 212 corresponds to a different type of opportunity to generate content (e.g., leave feedback).

As shown, entry 220 corresponds to a transaction having a date 222 of Oct. 12, 2012. Indicator 224 shows the transaction provider (“Munyon's BBQ Bistro”), while indicator 226 shows the total cost of this transaction. Visual element 228, in the embodiment of FIG. 2, is a button that can be selected by a user in order to cause the user to be given an opportunity to submit user generated content relating to purchase entry 220. As shown, element 228 corresponds to a particular website (“XYZ”), and selection of element 228 causes a computer system of the user to load a web page from website XYZ, at which the user can review the purchase at Munyon's BBQ Bistro. In some embodiments, for example, element 228 may allow a user to leave a restaurant review on a third-party review site such as YELP.COM, though element 228 is not thus limited. (Note that in general, many different types of user generated content can be submitted in association with transactions that are listed in an account statement, and that many different types of visual elements corresponding to the different types of user generated content may in some cases be presented on an account statement; the specific visual elements discussed relative to field 212 are simply non-limiting examples.)

In the example shown in FIG. 2, entry 230 corresponds to a transaction having a date 232 of Oct. 13, 2012 and having been conducted at provider 234 (“Home Emporium Ltd.”) for a particular total amount 236. Purchase details 235A-235D each correspond to particular portions of transaction entry 230, and are respectively associated with price detail information 237A-237D. In some embodiments, purchase details 235 may be unavailable (or not displayed on statement 200) for at least a portion of a transaction. In other embodiments, price details 237 may also be unavailable (or not displayed on statement 200) for all or a portion of a transaction.

In entry 230 in the embodiment of FIG. 2, visual element 238 corresponds to transaction provider 234 and/or to total purchase amount 236. As shown, selection of element 238 will cause a user to be provided with a “review store” opportunity for Home Emporium Ltd. Thus, in one embodiment, selecting element 238 may cause a web browser of a user to navigate to a page at which the user can create content (e.g., leave feedback) relating to transaction 230. Accordingly, visual element 238 may enable a user to, for example, provide a rating, provide an opinion, ask a question, document a problem, and/or answer a survey pertaining to an overall shopping experience at Home Emporium Ltd. Again, the type of content that may be submitted relative to a visual element such as 238 is not limited to the examples described herein.

Transaction entry 230, as depicted in the example of FIG. 2, includes two other visual elements 239A and 239B. Elements 239A and 239B are respectively associated with transaction details 235A and 235B and price details 237A and 237B. Thus, in one embodiment, visual element 239A is selectable to cause a user to be presented with a web page allowing review of a product associated with transaction detail 235A. In various embodiments, element 239A may allow the user to generate content related to a particular lawnmower model that is manufactured by BrandCo or content that is related to a commercial brand (or company) such as “BrandCo” itself. For example, a first UGC submission opportunity available through element 239A might provide prompts about the lawnmower purchase such as “rate this product 1 to 5 stars” or “rate the value of this product”, etc., while a second UGC submission opportunity available through element 239A might provide prompts about BrandCo itself (e.g., “on a scale of 1 to 10, how likely are you to buy another home appliance from BrandCo?”).

As shown, visual element 239B may allow a user to submit user generated content relating to the purchase of a BrandCo Cordless Drill (as indicated in transaction detail 235B). In one embodiment, selection of element 239B may cause a user's computing device to navigate to a website hosting a product support forum for any and all BrandCo manufactured items. The user may then be permitted or prompted to ask one or more questions relating to BrandCo itself, or to the particular BrandCo Cordless Drill model that was purchased for $84.99 on Oct. 12, 2012 (as indicated in transaction entry 230). Many other types of content submission opportunities are possible in various embodiments.

As shown in the embodiment of FIG. 2, an opportunity to submit user generated content may not be presented to a user for certain transaction details and/or transaction entries. As shown, there is no presented opportunity to submit content in association with transaction details 235C and 235D. Relative to detail 235C in one embodiment, a determination has been made that “miscellaneous hardware” is an item or item type of for which user generated content (e.g., feedback) will not be solicited. For example, “miscellaneous hardware” may include sundry nuts, bolts, and nails, or other products that are difficult to identify reliably. It may also be the case that various users or consumers (possibly including a user of financial account number 202) have little or no interest in seeing or submitting content that relates to “miscellaneous hardware” as shown in transaction detail 235C. Likewise, transaction detail 235D, which corresponds to a tax amount 237D, also does not have a visual element associated with it that would provide a user with the opportunity to generate content. In some embodiments, one or more whole transaction entries may have no associated visual elements allowing for the submission of related content. As discussed above and elsewhere herein, various factors may be used to determine whether or not a given transaction entry or transaction detail should give a user the opportunity to submit content.

In the embodiment of FIG. 2, transaction entry 240 corresponds to a transaction having a date 242 of Oct. 14, 2012 that has been conducted with provider 244 (“Acme Corporation”) for a particular total amount 246. As shown, two visual elements 248 and 249 are associated with transaction entry 240. In general, any given transaction entry and/or transaction detail may have zero, one, or two or more associated visual elements that are selectable to cause a user to be presented with opportunities to generate content (which may relate to a good and/or service). Visual elements 248 and 249 may correspond to the opportunity to submit any type of content relating to transaction entry 240, including user generated content related to a particular good or service, brand or company, or other type of content as would occur to one with skill in the art.

In various embodiments, verification of a user's consent may be a prerequisite for presenting the user with an opportunity to submit user generated content. As shown, user consent may be given by the user selecting visual element 275. For example, selection of element 275 may cause a pop-up window to be presented on a user's display, in which the user may agree to allow transaction and/or account information to be accessed in order to make determinations as to whether a content-generation opportunity should be presented. In some embodiments, user consent is obtained prior to making such determinations, and in one particular embodiment, user consent is obtained from an account holder via an agreement to the terms and conditions for the account. For example, at the time a cardholder signs up for an account, the cardholder may consent to allowing content generation opportunities to be determined. In another embodiment, consent may be given upon the cardholder using a website related to a credit card account or other financial account (e.g., consent may be part of the terms and conditions for use of the website). Thus, in some embodiments, solicitation of user consent (e.g., via visual element 275) does not occur in response to a user accessing account statement 200, but is instead provided to a user beforehand (e.g., via a previous screen or web page).

Visual element 280 may also allow a user, in the embodiment of FIG. 2, to specify various options relating to opportunities for submitting content. In the embodiment shown, element 280 is selectable by a user to specify preferences (e.g., via a child window) relating to the financial account and opportunities to submit content. These preferences may cause account statement 200 to subsequently be customized such that some transaction entries and/or transaction details may or may not have corresponding content-generation opportunities, depending on the preferences. In some embodiments, preferences are specified by an entity other than the user (e.g., an issuer of the financial account, an entity associated with provider system 120 or content opportunity system 130, etc.) and/or by the user via other means.

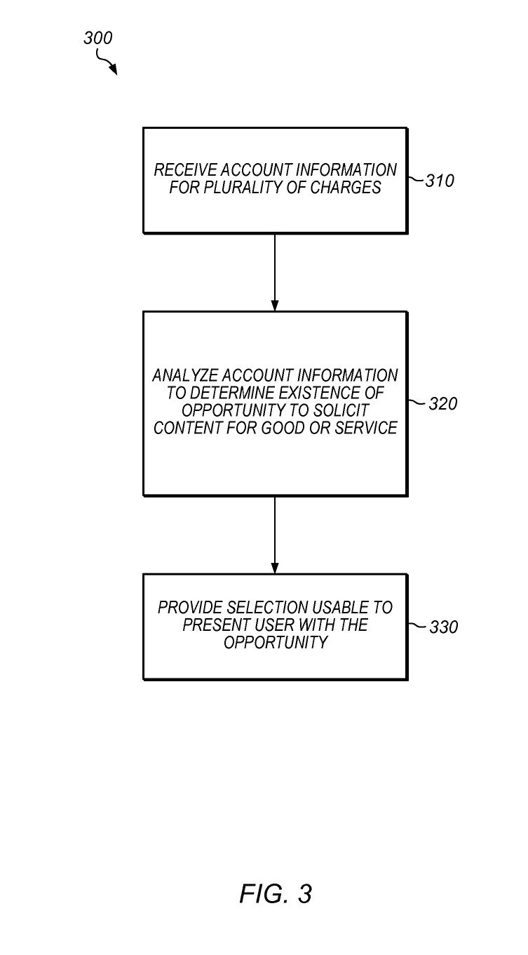

Turning now to FIG. 3, a flow diagram 300 of one embodiment of a method that relates to determining the existence of an opportunity to solicit user generated content for a good or service is shown. In one embodiment, all steps of method 300 are performed by account system 110, while in another embodiment all steps of method 300 are performed by content opportunity system 130. Method 300 is not thus limited, however, and one or more of its steps may be performed by any suitable computer system or combination of computer systems in various embodiments. As shown, method 300 includes steps 310, 320, and 330. In some embodiments, method 300 may include additional steps not depicted, as explained herein.

As shown, in step 310, a first computer system (e.g., account system 110) receives account information identifying a plurality of charges associated with a financial account of a user. In some embodiments, this account information includes information relating to one or more particular transactions conducting using the financial account.

In one embodiment, step 310 includes a first computer system receiving information from one or more provider systems 120 over a period of time. For example, each time a transaction occurs, a provider system 120 may transmit transaction-related information to the first computer system, such as date of purchase, item(s) purchased, total cost of purchase, costs of items, etc. (Such information may also be periodically batch-transmitted by provider system 120 in some embodiments.) Account information received at the first computer system from provider system(s) 120 may also specify an account number 202, or otherwise include information usable to determine a particular financial account to which a given transaction corresponds. In some embodiments, account information received at a first computer system includes all or substantially all transaction information for a plurality of transactions, while in other embodiments, the account information received in step 310 may omit one or more details that are transmitted or retained by provider system 120. In one embodiment, account information received at a first computer system includes only transaction-related information sent from a provider system 120 (e.g. the received account information does not include information from other sources in this embodiment).

In step 320, the first computer system analyzes the received account information to determine that an opportunity exists to solicit user generated content relating to a user's experience with a good or service associated with a particular one of the plurality of charges. In various embodiments, determining that an opportunity exists to solicit content may be based on any number of factors, and may include one or more additional steps or details. In one embodiment, determining that an opportunity exists to solicit content includes transmitting at least a portion of the account information to a second computer system and receiving, from the second computer system, a link to a website that provides the user with the opportunity to submit the content. In this embodiment, the first and second computer systems may be associated with different entities (e.g., the first computer system may be account system 110 while the second computer system is content opportunity system 130). The second computer system may also be configured to determine an address of the link (e.g., determine the content-generation opportunity to be presented) based on one or more business rules, user preferences, etc.

As shown in step 330, the first computer system provides information usable by a remote computing device to cause display of a first visual element associated with a particular charge. This visual element is selectable, in the embodiment of FIG. 3, to cause a user to be presented with an opportunity to submit user generated content relating to the user's experience with a good or service associated with the particular charge. In one embodiment, the first visual element that is presented may be any one of the visual elements appearing in field 212 of account statement 200. Accordingly, in various embodiments, the visual element that is displayed to a user may be selected to cause a web page to be presented to the user. One or more prompts for information (prompts for UGC) may then be filled out by the user via the web page. In at least one embodiment of step 330, the term “providing information usable to cause display of a first visual element” refers to transmitting information to a remote computing device that is configured, upon receipt of the information, to display the visual element on an output of the remote computing device. In some embodiments, this may comprise transmitting all or a portion of a web page or PDF file. Thus, in one embodiment, step 330 includes content opportunity system 130 providing information to a user computing device 102.

In one embodiment of method 300, a first computer system (that receives and analyzes account information) is associated with a first website for an issuer of a financial account. For example, the first computer system may be account system 110, and may be associated with a first website such as CITICARDS.COM (a website related to credit cards). The first visual element may be displayed to a user as part of the first website, and may be selected at the first website to cause the opportunity to submit content to be presented as part of a second website. For example, the second website may be a third party review website or a website for a good or service provider, and may be a website such as YELP.COM, BESTBUY.COM, SAMSUNG.COM, etc. Thus, in one embodiment, a user selects a visual element from a first website associated with an issuer of a financial account, and the user's computing device then subsequently displays a second website that allows the user to submit content relating to a good or service.

In one embodiment, a particular charge corresponds to the user's purchase of a good or service for which an opportunity to submit content exists. Thus, selecting a visual element may cause the user to be given an opportunity to submit user generated content for a good or service that the user has actually purchased using the financial account. In one further embodiment, method 300 includes providing information certifying that a good or service associated with a particular charge is purchased (or has been purchased) using a particular financial account. For example, the first computer system may provide information to a second computer system (e.g., content opportunity review system 130 or external site system 140) that allows the second computer system to rely on any user generated content as being related to an actual, verified purchase. UGC that relates to a verified purchase, in some embodiments, may be more useful or commercially valuable than non-verified UGC.

User consent is used, in some embodiments of method 300, as a basis for analyzing account information to determine that an opportunity exists to solicit content. For example, before a first computer system can determine that such an opportunity exists, the first computer system may be required to obtain or verify user consent as a prerequisite to perform the analysis. In one embodiment, user consent is given as part of the terms of service (ToS) for a financial account. In another embodiment, user consent is given as part of the ToS for a website associated with the financial account. In yet another embodiment, user consent may be obtained dynamically at the time an account statement 200 is provided, shortly beforehand, or even after providing an account statement (e.g., in response to a user selecting a visual element from field 212, a pop-up window could then be used to obtain consent).

In some embodiments, content generation opportunities are provided for additional goods and/or services. Thus in one embodiment, method 300 further comprises receiving transaction data for a particular charge from a provider at which a good or service is purchased. This transaction data may include information specifying a first good or service and at least a second, additional good or service. Method 300 may further comprise providing information usable by a remote computing device to cause display of a second visual element associated with the particular charge. Thus, in various embodiments, any given transaction and/or transaction detail may have two or more content generation opportunities and respective visual elements associated with the transaction and/or transaction detail. (For example, see visual elements 248 and 249 in the embodiment of FIG. 2.) A second visual element may be selectable, in the above-described embodiments, to cause a user to be presented with an opportunity to submit content relating to the user's experience with the additional (second) good or service. Accordingly, in various embodiments, any particular transaction may cause a first computer system to receive transaction information from a provider system and allow a user to submit content relating to a plurality of goods and/or services.

In some embodiments, a first computer system may determine not to provide an opportunity to submit user generated content for a particular good or service. Thus, in some embodiments there are circumstances in which a user might be presented with the opportunity to submit content, but for one or more reasons the first computer system determines not to provide such an opportunity. In one embodiment, a determination not to provide a content submission opportunity is based on one or more preferences. For example, a user, account issuer, or other entity may specify preferences such as “do not present content submission opportunities for purchases under $5.00” or “do not present content submission opportunities for purchases made at gas stations or grocery stores.” In some embodiments, such preferences may prevent a user from being overwhelmed with excessive information, and ensure that only content submission opportunities deemed to be of sufficient importance (e.g., submission opportunities related to only select purchases) are presented. In other embodiments, a user may also use preferences to positively specify purchases or types of purchases for which the user wishes to be offered the chance to submit content. For example, in various embodiments, a user might specify that he wishes to have the chance to submit reviews for all purchases, wherever possible, of footwear, music, bars/restaurants, and/or other types of goods or services. Compound rules or preferences with two or more criteria are also contemplated (e.g., “I wish to have the chance to review all purchases from TARGET (a retail store) that are $5.00 or greater”).

In other embodiments, a determination is made not to present content submission opportunities based on business agreements that an entity associated with the first computer may have with another entity. For example, an account issuer may have an agreement with one provider not to provide (or to limit) content submission opportunities for another provider. Or, an account issuer may not have an agreement with a particular provider, and may choose not to provide a statement 200 that allows a user to provide user generated content relating to purchases for that particular provider. In yet another embodiment, a content submission opportunity may not be provided based on a determination that the content submission opportunity relates to a good or service that is potentially offensive, or based on a determination that a business rule otherwise specifies that the content submission opportunity should not be presented. Determining not to present a content submission opportunity may be based on any number of factors, however, and is not limited to the examples above.

Accordingly, in one embodiment, method 300 comprises determining to provide an opportunity to submit user generated content for a first one of a plurality of goods or services purchased using a particular charge, and determining not to provide an opportunity to submit content for another (second) one of the plurality goods or services that was also purchased using the particular charge. However, determining not to provide a given content submission opportunity is not limited to situations in which the given opportunity is part of a plurality of goods or services purchased with a single charge (or single transaction).

In various embodiments, an account statement (e.g., statement 200) may specify a plurality of goods or services purchased in a plurality of transactions using a financial account associated with that account statement. Accordingly, such an account statement may be included in information provided to a remote computing device 102 by a first computer system (e.g., account system 110). In one embodiment, each of a plurality of goods or services specified in an account statement may be selectable to cause presentation (e.g., on a display of device 102) of an opportunity to submit user generated content relating to a user's experience with that good or service. Thus, an account statement may include, in various embodiments, any number of transactions and the ability to submit content relating to goods or services purchased in those transactions. Note that in various embodiments, an opportunity to submit content may not be provided for all transactions, goods, and/or services, while some transactions, some or all goods and/or services may have two or more corresponding opportunities to submit content.

A request for account information identifying a plurality of charges may be received by a first computer system in some embodiments. For example, a user may transmit a request from a computing device 102 to account system 110 in order to retrieve a monthly account statement. In response to such a request, the first computer system may provide information that is usable by a remote computing device (e.g., device 102) to cause display of a first visual element that is selectable to present a user with the opportunity to submit user generated content relating to the user's experience with a good or service corresponding to a particular charge associated with a financial account. Thus, in some embodiments, all or a portion of steps 310-330 of method 300 may be performed in response to a user request for an account statement.

In one or more embodiments, a computer readable medium may include instructions executable to cause a computer system to perform all or a portion of method 300, including but not limited to steps 310-330 and any and all related embodiments as described above and/or herein.

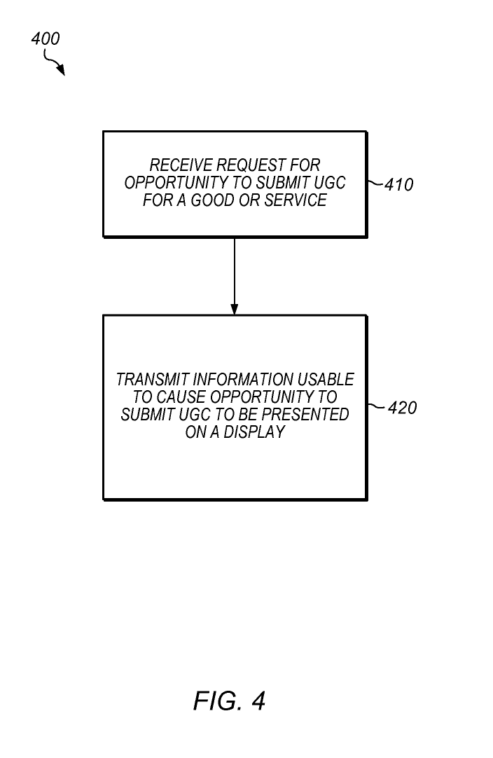

Turning now to FIG. 4, a flow diagram 400 shows an embodiment of a method for transmitting information usable to cause an opportunity to submit UGC for a particular good or service to be presented on a display of a second computer system. In one embodiment, all steps of method 400 are performed by content opportunity system 130, while in another embodiment all steps of method 400 are performed by account system 130. Method 400 is not thus limited, however, and may be performed by any suitable computer system in various embodiments. As shown, method 400 includes steps 410 and 420. In some embodiments, method 400 may include additional steps (not depicted), as discussed herein.

In the embodiment of FIG. 4, step 410 includes receiving, at a first computer system (e.g., system 130), a request for an opportunity to submit user generated content (UGC) for a particular good or service (e.g., a user-submitted rating, review, question, answer, and/or other data conveying fact or opinion relating to the particular good or service). This request may be received in response to a user selecting a portion of an account statement for a financial account. The selected portion of the account statement may be associated with the particular good or service and a particular one of a plurality of transactions specified by the account statement. The account statement may include transaction information for at least two different providers. In one embodiment, the selection portion of the account statement comprises a visual element such as one appearing in field 212 of FIG. 2.

As shown, step 420 includes the first computer system, in response to receiving the request for the opportunity to submit UGC, transmitting information to a second computer system (e.g., user computing device 102 or account system 110) that is usable to cause the opportunity to submit the UGC for the particular good or service to be presented on a particular display. In one embodiment, the particular display is a display of the second computer system to which the information is transmitted. Accordingly, in at least one embodiment, method 400 includes receiving (e.g., at content opportunity system 130) a request for an opportunity to submit UGC and subsequently transmitting information to a user computing device 102. In one embodiment, a user of computing device 102 may login to account system 110, which causes a request for an opportunity to submit UGC to be sent to content opportunity system 130. This request may be sent directly from device 102 in some embodiments, while in other embodiments, this request may be sent from account system 110 to content opportunity system 130.

In one embodiment, method 400 includes aggregating UGC from a plurality of users for a provider associated with a particular good or service. For example, UGC for a provider such as WALMART (e.g., UGC relating to users' experiences with the provider and/or with goods/services offered by that provider) may be collected (aggregated) at a particular computer system such as system 130. In one or more embodiments, this aggregated UGC may include various UGC from different users and/or financial account holders. In one or more embodiments, aggregated UGC may also correspond to any number of different goods or services purchased from a particular provider.

In one embodiment, an opportunity to use aggregated UGC may be offered to a provider in exchange for a premium. As used herein, the term “premium” may refer to monetary or non-monetary compensation (such as rewards, rewards points, discounts, goods and/or services, etc.). For example, content opportunity system 130 may aggregate UGC for a provider and then give that provider access to all or a portion of the aggregated UGC in exchange for a premium. This exchange may be memorialized in a contract or other agreement between a provider and an entity associated with content opportunity system 130 (such as a third party content processing entity) in various embodiments. In some embodiments, the premium may be based on the amount of UGC that is given to a provider of goods/services by a content processing entity. In other embodiments, the premium may be based on a time period of service.

Further, in some embodiments, UGC relating to a particular provider may be aggregated prior to offering that provider the opportunity to use the aggregated UGC. For example, UGC for a new restaurant may be aggregated by system 130 prior to the new restaurant entering into any agreement with an entity associated with system 130. The new restaurant may then be offered the opportunity to use all or a portion of the aggregated content. In one embodiment, (aggregated) UGC may consist of ratings on a scale of one to five stars from various financial account holders. A new restaurant could then be given an offer that informs them that 25 reviews have been gathered to date with an average rating of 4.1 stars. The new restaurant could then decide to give a premium in order to use those reviews. One such use of the reviews could be displaying them on the new restaurant's website. Another such use may be providing all or a portion of the reviews to a third party review site such as YELP.COM or GOOGLE.COM (possibly subject to terms and conditions of the external site). However, aggregating UGC prior to a provider actually using the aggregating UGC is not limited to the example above, and can be performed for manufacturers with new products or for any other use or situation as would occur to one with skill in the art.

In one embodiment of method 400, information transmitted to a second computer system includes a link to a resource hosted by a first computer system. For example, information transmitted to the second computer system may include a link to an interface (i.e., a resource) allowing for the submission of UGC. Such a link, in some embodiments, may be a URI that points to a network location associated with content opportunity system 130. Note that in various embodiments, the term “interface” broadly refers to any web page, script, compiled code, interpretable code, compilable code, portion of a database, HTML, or other digital information that is usable by a computer system to cause UGC to be transmitted to another computer system.

In one or more embodiments, a computer readable medium may include instructions executable to cause a computer system to perform all or a portion of method 400, including but not limited to steps 410-420 and any and all related embodiments as described above and/or herein.

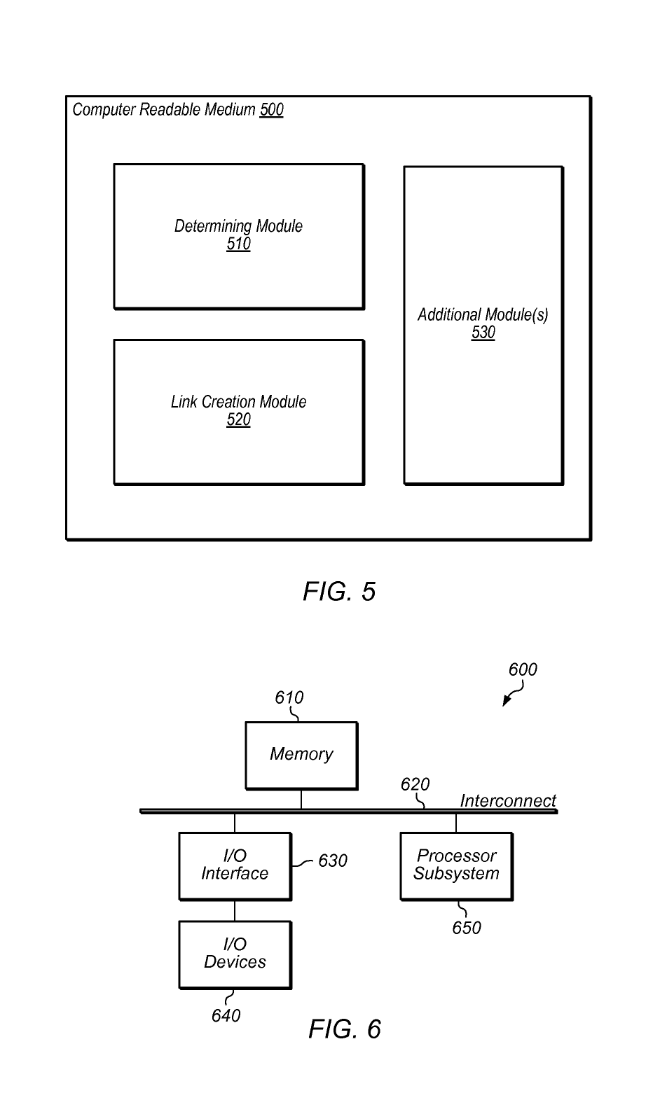

Turning now to FIG. 5, computer readable storage medium 500 is shown. In various embodiments, any or all of the modules (or a portion thereof) in medium 500 can be present in any computer system or computing device described herein (e.g., such as content opportunity system 130 or account system 110). As shown, computer readable storage medium 500 includes a determining module 510 and a link creation module 520. In some embodiments, one or more additional modules 530 may also be present, which may be executed to cause one or more additional steps to be performed.

As shown, module 510 includes instructions that are executable to cause a first computer system to determine, based on transaction data for a plurality of transactions charged to a financial account of a user, that an opportunity exists to solicit a user to submit user generated content relating to a good or service identified in the transaction data. This determination may, in various embodiments, include any or all features of analyzing step 320 of method 300. (Note also that in general, any steps, details, or features found in method 300, method 400, and computer readable medium 500 may be suitably combined as consistent with this disclosure). In one embodiment, module 510 is configured to allow a determination to be made based on one or more business rules, the existence of a relationship (e.g., a contract) between a first entity associated with content opportunity system 130 and a provider associated with provider system 120, or any other determining or analyzing step(s) described herein as consistent with this disclosure. Accordingly, in some embodiments, module 510 may also make a determination about the existence of an opportunity to submit content based on transaction data that includes pricing data, provider data, data describing a good and/or service, or any other transaction-related data as described herein or would occur to a person of skill in the art.

Module 520 includes instructions that are executable, in the embodiment of FIG. 5 to cause a first computer system to create, based on determining step 510, a link that is selectable (e.g., at a second computer system) to cause an opportunity to submit content to be presented on a display of the second computer system. Such a link may be embeddable in account statement for a financial account. For example, the created link may be a URI that is included in a web page and/or PDF statement. The term “embeddable,” in various embodiments, denotes that the link may be included in an account statement 200 without corrupting digital information that comprises that account statement (e.g., without altering the account statement such that one or more of its functionalities are prevented from operating).

In one embodiment, module(s) 530 includes instructions that are executable to cause transmission of linking information to a computer system associated with an issuer of a financial account. Such linking information may be configured to be usable by the computer system associated with the issuer of the financial account to cause a created link to be embedded in an account statement for the financial account. Thus, in one embodiment, account system 110 may receive linking information from content opportunity system 130, and be configured to embed that received linking information in an account statement 200 and to provide the account statement to a user computing device 102. Linking information may, in various embodiments, include all or a portion of a created link as well as additional information (e.g., graphics, text, script or other executable code, database access information, etc.).

In another embodiment, a plurality of transactions that are charged against a financial account by a plurality of different providers may be received over a particular period of time. For example, a credit-card related financial account may have charges incurred over a roughly 30 day (monthly) period of time. In this and other embodiments, a first computer system (such as content opportunity system 130) may receive transaction data for a plurality of transactions from an issuer of the financial account. For example, content opportunity system 130 may receive transaction data from account system 110. The received transaction data may then be used by content opportunity system 130 to determine that an opportunity exists to submit content relating to a good or service.

In some embodiments, a created link may be selectable to cause a display of a second computer system to be presented with a website that is associated with a provider of a good or service, where the website provides an opportunity for a user to submit user generated content relating to the good or service. Accordingly, in one embodiment, content opportunity system 130 may create or provide a link that, when selected, will cause a browser of a user's computing device 102 to navigate to a website of a provider at which content (e.g. feedback) can be submitted. For example, consider a user that has purchased a 60 inch LCD television from SAMSUNG CORP. using his or her credit card. Content opportunity system 130 may create a link that becomes embedded in the user's statement 200, where selection of the link provides an opportunity for the user to review the 60 inch LCD television on a website affiliated with SAMSUNG CORP. (Note that in various embodiments, all or a portion of actions caused by executing modules 510-530 may be transparent to a user—for example, the user may not be aware that content opportunity system 130 is taking particular steps, but instead may simply experience the results via websites associated with account system 110 and/or provider system 120.)

Creating a link using the embodiment of FIG. 5 may be based on one or more preferences specified for a financial account. Such preferences may be specified a by a user or other entity (e.g., an entity corresponding to at least one of systems 110-140), and may relate to at least one of price, provider, type of good or service, or location. For example, a user may specify that he or she wishes to have the opportunity, wherever possible, to review all goods or services costing $100 or more, review all goods or services from a particular provider or provider website (e.g., TARGET.COM), or review all travel-related services (e.g., rental cars, hotels, etc.). In some embodiments, compound rules or preferences may be used. For example, a user (or other entity) may specify that he or she wishes to have the opportunity to review (or not review), wherever possible, all restaurants within 75 miles of home having an associated charge of at least $10.00 or more. Many preference-related variations are possible, however, and are not limited to the examples discussed herein.

In one embodiment, a first computer system (e.g., content opportunity system 130) may store at least a portion of received transaction data and use the stored data to determine that other opportunities exist for one or more other users associated with one or more other financial accounts to submit user generated content. In some embodiments, user permission may be gathered prior to storing transaction data and using it relative to other users and/or other financial accounts. This stored data may be used for statistical and/or heuristic purposes.

For example, a first user might make a purchase for good G from provider P. Based on whether the first user actually submitted user generated content for good G, a first computer system might (or might not) determine that another user should be presented with an opportunity to submit content for good G (i.e., determine that a content submission opportunity exists relative to another user). Further, statistics can be gathered. As another example, consider 10,000 users (e.g., a threshold amount of users) that were all offered the opportunity to review good G, but that only 3 out of 10,000 actually submitted content. It could be concluded based on this sample that many or most users are not interested in submitting content relating to good G, and subsequent purchasers of good G may therefore not be offered the opportunity to provide feedback for good G (or will be offered the opportunity to provide content at a lower rate of incidence). Alternately, specific promotions (e.g., rebates, coupons, rewards points) may be offered to encourage users to provide feedback for good G.

In some embodiments, first and second users that have purchased a particular good or product within same or different timeframes may not both be offered the same opportunity to submit a review for the particular good or product. For example, it may be the case that one, but not the other, is offered such a UGC submission opportunity (e.g., based on a more granular analysis of user-specific data, such as UGC submission history, purchase history, demographic data, etc.) Alternately, one but not the other may be offered specific promotions to encourage submission of UGC relating to the particular good or product. The specification is not limited to the examples above, however (for example, such techniques for using stored data from another user are equally applicable to service-related purchases).

### Exemplary Computer System

Turning now to FIG. 6, one embodiment of an exemplary computer system 600 is depicted. Computer system 600 includes a processor subsystem 650 that is coupled to a system memory 610 and I/O interfaces(s) 630 via an interconnect 620 (e.g., a system bus). I/O interface(s) 630 are coupled to one or more I/O devices 640. Computer system 600 may be any of various types of devices, including, but not limited to, a server system, personal computer system, desktop computer, laptop or notebook computer, mainframe computer system, handheld computer, workstation, network computer, or a device such as a mobile phone, pager, or personal data assistant (PDA). Computer system 600 may also be any type of networked peripheral device such as storage devices, switches, modems, routers, etc. Although a single computer system 600 is shown for convenience, the system may also be implemented as two or more computer systems operating together.

Processor subsystem 650 may include one or more processors or processing units. In various embodiments of computer system 600, multiple instances of the processor subsystem may be coupled to interconnect 620. In various embodiments, processor subsystem 650 (or each processor unit within the subsystem) may contain a cache or other form of on-board memory. In one embodiment, processor subsystem 650 may include one or more processors.

System memory 610 is usable by processor subsystem 650. System memory 610 may be implemented using different physical memory media, such as hard disk storage, floppy disk storage, removable disk storage, flash memory, random access memory (RAM-SRAM, EDO RAM, SDRAM, DDR SDRAM, RDRAM, etc.), read only memory (PROM, EEPROM, etc.), and so on. Memory in computer system 600 is not limited to primary storage. Rather, computer system 600 may also include other forms of storage such as cache memory in processor subsystem 650 and secondary storage on the I/O Devices 640 (e.g., a hard drive, storage array, etc.). In some embodiments, these other forms of storage may also store program instructions executable by processor subsystem 650.

I/O interfaces 630 may be any of various types of interfaces configured to couple to and communicate with other devices, according to various embodiments. In one embodiment, I/O interface 630 is a bridge chip (e.g., Southbridge) from a front-side to one or more back-side buses. I/O interfaces 630 may be coupled to one or more I/O devices 640 via one or more corresponding buses or other interfaces. Examples of I/O devices 640 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device. The network interface device may be a wireless interface in various embodiments. In other embodiments, computer system 600 is part of a cloud-based computing service. In general, the present disclosure is not limited to any particular type of computer architecture.

### Computer-Readable Medium

The above-described techniques and methods may be implemented as computer-readable instructions stored on any suitable computer-readable storage medium. As used herein, the term computer-readable storage medium refers to a (nontransitory, tangible) medium that is readable by a computing device or computer system, and includes magnetic, optical, and solid-state storage media such as hard drives, optical disks, DVDs, volatile or nonvolatile RAM devices, holographic storage, programmable memory, etc. The term “non-transitory” as applied to computer-readable media herein is only intended to exclude from claim scope any subject matter that is deemed to be ineligible under 35 U.S.C. §101, such as transitory (intangible) media (e.g., carrier waves per se), and is not intended to exclude any subject matter otherwise considered to be statutory. Computer-readable storage mediums can be used, in various embodiments, to store executable instructions and/or data. In some embodiments, particular functionality may be implemented by one or more software “modules”. A software module may include one or more web applications in some embodiments, and may make use of PHP, JAVASCIPT, HTML, Objective-C, JAVA, or any other technology that allows any two computing devices or computer systems to interact with one another (for example, allowing a user computing device 102 to interact with account server 110). In various embodiments, software functionality may be split across one or more modules and/or may be implemented using parallel computing techniques, while in other embodiments various software functionality may be combined in single modules. Software functionality may be implemented and/or stored on two or more computer systems (e.g., a server farm, or a front-end server and a back-end server and/or other computing devices such as device 102) in some embodiments.

### Exemplary Embodiments

One embodiment is a method, and comprises a first computer system receiving account information identifying a plurality of charges associated with a financial account of a user, the first computer system analyzing the account information to determine that an opportunity exists to solicit content relating to the user's experience with a good or service associated with a particular one of the plurality of charges, and the first computer system providing information usable by a remote computing device to cause display of a first visual element associated with the particular charge, wherein the first visual element is selectable to cause the user to be presented with an opportunity to submit the content. In a further embodiment, the first computer system is associated with a first website for an issuer of the financial account, wherein selecting the first visual element at the first website causes the opportunity to submit the content to be presented as part of a second website, and wherein the particular charge corresponds to the user's purchase of the good or service. In another further embodiment, said analyzing the account information to determine that the opportunity exists to solicit the content includes transmitting at least a portion of the account information to a second computer system, wherein the first and second computer systems respectively correspond to different entities, and includes receiving, from the second computer system, a link to a website that includes a presentation of the opportunity to submit the content, wherein the second computer system is configured to determine an address of the link based on one or more business rules and the at least a portion of the account information. In another further embodiment, said analyzing the account information to determine that the opportunity exists to solicit the content is performed based on consent of the user. In another further embodiment, the first computer system (or another computer system) receives transaction data for the particular charge from a system associated with a provider from which the good or service is purchased, wherein the transaction data includes information specifying the good or service and at least one additional good or service, and provides information usable by the remote computing device to cause display of a second visual element associated with the particular charge, wherein the second visual element is selectable to cause the user to be presented with an opportunity to submit content relating to the user's experience with the at least one additional good or service. In another further embodiment, the first computer system (or another computer system) determines to provide an opportunity to submit content for at least one of a plurality of goods or services purchased using the particular charge, and determines not to provide an opportunity to submit content for another one of the plurality of goods or services purchased using the particular charge. In another further embodiment, the first computer system (or another computer system) provides an account statement to the remote computing device, wherein the account statement includes information specifying a plurality of goods or services purchased in a plurality of transactions using the financial account, wherein two or more of the plurality of goods or services are each selectable to cause an opportunity to submit content relating to the user's experience with that good or service to be presented. In another further embodiment, the first computer system (or another computer system) provides information certifying that the good or service associated with the particular charge is purchased using the financial account. In another further embodiment, the first computer system (or another computer system) receives a request for the account information and, in response to the request, provides the information usable by the remote computing device to cause display of the first visual element.

In another embodiment, a computer-readable storage medium has stored thereon instructions that are executable by a first computer system to cause the first computer system to perform operations comprising: determining, based on transaction data for a plurality of transactions charged to a financial account of a user, that an opportunity exists for the user to submit content relating to a good or service identified in the transaction data, and, based on said determining, creating a link that is selectable to cause the opportunity to submit the content to be presented on a display of a second computer system, wherein the link is embeddable in an account statement for the financial account. In a further embodiment, the plurality of transactions are charged against the financial account by a plurality of different providers over a particular period of time, and the operations further comprise receiving the transaction data from a system associated with an issuer of the financial account. In another further embodiment, the operations further comprise transmitting linking information to a computer system associated with an issuer of the financial account, wherein the linking information is configured to be usable by the computer system associated with the issuer of the financial account to cause the link to be embedded in an account statement for the financial account. In another further embodiment, the link is selectable to cause the display of the second computer system to show a website associated with a provider of the good or service, wherein the opportunity for the user to submit content is displayed within the website. In another further embodiment, the operations further comprise creating the link based on one or more user preferences specified for the financial account, wherein the user preferences relate to at least one of price, provider, or type of good or service. In another further embodiment, the operations further comprise storing at least a portion of the transaction data and using the stored data in determining that another opportunity exists for one or more other users associated with one or more other financial accounts to submit content.

In yet another embodiment, a method comprises receiving, at a first computer system, a request for an opportunity to submit user generated content (UGC) for a particular good or service, wherein the request is received in response to a user selecting a portion of an account statement for a financial account, wherein the portion of the account statement is associated with the particular good or service and a particular one of a plurality of transactions specified by the account statement, and wherein the account statement includes transaction information for at least two different providers, and, in response to the receiving, the first computer system transmitting, to a second computer system, information usable to cause the opportunity to submit the UGC for the particular good or service to be presented on a computer display. In another further embodiment, the first computer system (or another computer system) aggregates UGC from a plurality of users for a provider associated with the particular good or service, and subsequent to said aggregating, offers the provider the opportunity to use the aggregated UGC in exchange for a premium, wherein the provider was not using the one or more reviews prior to said offering. In another further embodiment, the first computer system (or another computer system) aggregates UGC from a plurality of users for a provider associated with the particular good or service, and submits the aggregated UGC to a third party review site, wherein the aggregated UGC includes a plurality of reviews for the particular good or service. In another further embodiment, the financial account is at least one of a credit card account or debit card account, and the information transmitted to the second computer system includes a link to a resource hosted by the first computer system. In another further embodiment, the second computer system is a computing device associated with a user of the financial account.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Additionally, section or heading titles provided above in the detailed description should not be construed as limiting the disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A method, comprising:
a first computer system receiving account information identifying a plurality of charges associated with a financial account of a user;
the first computer system analyzing the account information to determine that an opportunity exists to solicit content from the user relating to the user's experience with a good or service associated with a particular one of the plurality of charges; and
the first computer system providing information usable by a remote computing device to cause display of a first visual element associated with the particular charge, wherein the first visual element is selectable to cause the user to be presented with an opportunity to submit the content.

2. The method of claim 1, wherein the first computer system is associated with a first website for an issuer of the financial account, wherein selecting the first visual element at the first website causes the opportunity to submit the content to be presented as part of a second website, and wherein the particular charge corresponds to the user's purchase of the good or service.

3. The method of claim 1, wherein said analyzing the account information to determine that the opportunity exists to solicit the content includes:
transmitting at least a portion of the account information to a second computer system, wherein the first and second computer systems respectively correspond to different entities; and
receiving, from the second computer system, a link to a website that includes a presentation of the opportunity to submit the content, wherein the second computer system is configured to determine an address of the link based on one or more business rules and the at least a portion of the account information.

4. The method of claim 1, wherein said analyzing the account information to determine that the opportunity exists to solicit the content is performed based on consent of the user.

5. The method of claim 1, further comprising:
receiving transaction data for the particular charge from a system associated with a provider from which the good or service is purchased, wherein the transaction data includes information specifying the good or service and at least one additional good or service; and
providing information usable by the remote computing device to cause display of a second visual element associated with the particular charge, wherein the second visual element is selectable to cause the user to be presented with an opportunity to submit content relating to the user's experience with the at least one additional good or service.

6. The method of claim 1, wherein the method further comprises:
determining to provide an opportunity to submit content for at least one of a plurality of goods or services purchased using the particular charge; and
determining not to provide an opportunity to submit content for another one of the plurality of goods or services purchased using the particular charge.

7. The method of claim 1, further comprising providing an account statement to the remote computing device, wherein the account statement includes information specifying a plurality of goods or services purchased in a plurality of transactions using the financial account;
wherein two or more of the plurality of goods or services are each selectable to cause an opportunity to submit content relating to the user's experience with that good or service to be presented.

8. The method of claim 1, further comprising providing information certifying that the good or service associated with the particular charge is purchased using the financial account.

9. The method of claim 1, further comprising the first computer system receiving a request for the account information and, in response to the request, providing the information usable by the remote computing device to cause display of the first visual element.

10. A non-transitory, computer-readable medium having stored thereon instructions that are executable by a first computer system to cause the first computer system to perform operations comprising:
determining, based on transaction data for a plurality of transactions charged to a financial account of a user, that an opportunity exists for the user to submit content relating to a good or service identified in the transaction data; and
based on said determining, creating a link that is selectable to cause the opportunity to submit the content to be presented on a display of a second computer system, wherein the link is embeddable in an account statement for the financial account.

11. The non-transitory, computer-readable medium of claim 10, wherein the plurality of transactions are charged against the financial account by a plurality of different providers over a particular period of time, and wherein the operations further comprise receiving the transaction data from a system associated with an issuer of the financial account.

12. The non-transitory, computer-readable medium of claim 10, wherein the operations further comprise transmitting linking information to a computer system associated with an issuer of the financial account, wherein the linking information is configured to be usable by the computer system associated with the issuer of the financial account to cause the link to be embedded in an account statement for the financial account.

13. The non-transitory, computer-readable medium of claim 10, wherein the link is selectable to cause the display of the second computer system to show a website associated with a provider of the good or service, wherein the opportunity for the user to submit content is displayed within the website.

14. The non-transitory, computer-readable medium of claim 10, wherein the operations further comprise creating the link based on one or more user preferences specified for the financial account, wherein the user preferences relate to at least one of price, provider, or type of good or service.

15. The non-transitory, computer-readable medium of claim 10, wherein the operations further comprise storing at least a portion of the transaction data and using the stored data in determining that another opportunity exists for one or more other users associated with one or more other financial accounts to submit content.

16. A method, comprising:
receiving, at a first computer system, a request for an opportunity to submit user generated content (UGC) for a particular good or service, wherein the request is received in response to a user selecting a portion of an account statement for a financial account, wherein the portion of the account statement is associated with the particular good or service and a particular one of a plurality of transactions specified by the account statement, and wherein the account statement includes transaction information for at least two different providers; and
in response to the receiving, the first computer system transmitting, to a second computer system, information usable to cause the opportunity to submit the UGC for the particular good or service to be presented on a computer display.

17. The method of claim 16, further comprising:
aggregating UGC from a plurality of users for a provider associated with the particular good or service; and
subsequent to said aggregating, offering the provider the opportunity to use the aggregated UGC in exchange for a premium, wherein the provider was not using the one or more reviews prior to said offering.

18. The method of claim 16, further comprising:
aggregating UGC from a plurality of users for a provider associated with the particular good or service; and
submitting the aggregated UGC to a third party review site, wherein the aggregated UGC includes a plurality of reviews for the particular good or service.

19. The method of claim 16, wherein the financial account is at least one of a credit card account or debit card account, and wherein the information transmitted to the second computer system includes a link to a resource hosted by the first computer system.

20. The method of claim 16, wherein the second computer system is a computing device associated with a user of the financial account.
